(19) United States
(12) Patent Application Publication
(10) Pub. No.: US 2026/0058514 A1
(43) Pub. Date: Feb. 26, 2026

(54) COIL SYSTEM FOR A SUPERCONDUCTING MOTOR

(71) Applicant: Airbus (S.A.S.), Blagnac Cedex (FR)

(72) Inventors: Alexandre COLLE, Blagnac (FR); Reda ABDOUH, Blagnac (FR)

(21) Appl. No.: 18/676,777

(22) Filed: May 29, 2024

(30) Foreign Application Priority Data
May 30, 2023 (FR) 2305357

(51) Int. Cl. H02K 3/34; H02K 15/043; H02K 15/122; H02K 55/00

(52) U.S. Cl. CPC H02K 3/34; H02K 15/0431; H02K 15/122; H02K 55/00

(57) ABSTRACT

A coil system for a motor including a coil formed from strips and including straight sections passing through apertures of the motor, and, for each straight element of the coil passing through the same aperture, a shielding system with at least one first band and at least one second band arranged on either side of the elements, in which the strips are electrically connected to an electrical power source, in which two successive strips in the stack are electrically insulated from each other, and in which each band that is placed next to a strip of the coil is electrically insulated from the strip. With such an arrangement, the losses are reduced.

### TECHNICAL FIELD

The disclosure herein relates to the general field of superconducting motors and relates more particularly to a coil system for a superconducting motor and to a superconducting motor comprising a plurality of such coil systems. The disclosure herein also relates to a method for manufacturing such a coil system.

### BACKGROUND

FIG. 1 shows a superconducting motor 300, in which the superconducting motor 300 is shown in cross section through a plane perpendicular to the longitudinal axis X of the superconducting motor 300.

The superconducting motor 300 comprises a rotor 302 that has a rotor core 304 made from a ferromagnetic material such as all of the iron alloys used for electric machines. The rotor core 304 is cylindrical and coaxial with the longitudinal axis X and has a central bore 306 into which a motor shaft 308 of the superconducting motor 300 is inserted and rigidly fastened. The motor shaft 308 is coaxial with the longitudinal axis X.

The rotor 302 also comprises permanent magnets 310 fastened to the rotor core 304 around its periphery. There are several permanent magnets 310 (in this case, six) spaced apart from each other at regular angular intervals around the rotor core 304. Conventionally, the permanent magnets 310 are magnetized radially in relation to the longitudinal axis X and in an alternating manner, gradually.

The superconducting motor 300 comprises a stator 312 arranged outside the rotor 302 and comprises a stator core 314 made from a ferromagnetic material such as all of the iron alloys used for electric machines. The stator core 314 has a generally cylindrical shape coaxial with the longitudinal axis X.

On its cylindrical surface that is oriented towards the rotor 302, the stator core 314 has apertures 316, in this case in the form of slots, which open towards the rotor 302. There are several apertures 316 (in this case, sixteen) distributed at regular angular intervals around the rotor 302. The apertures 316 are arranged in pairs and the two apertures 316 of the pair are separated by a tooth 318 formed as a one-piece, single-material component with the stator core 314.

For each pair of apertures 316, the stator 312 comprises a coil 320 that is wound around the tooth 318. Each coil 320 is formed from a superconducting material.

The rotor 302 and the stator 312 are conventionally housed in a cylindrical motor casing 322 which is closed at both ends by walls, at least one of which has a central bore through which the motor shaft 308 can pass. The stator 312 is fixedly mounted inside the motor casing 322, while the rotor 302 and the motor shaft 308 are mounted so as to be able to rotate freely inside the motor casing 322, for example by bearings.

During operation, each coil 320 is supplied with electricity to generate a magnetic field that interacts with the permanent magnets 310 in order to rotate them with the rotor 302 and the motor shaft 308.

The superconducting motor 300 comprises an inner cylinder 324 and an outer cylinder 326 that are coaxial with the longitudinal axis X.

The inner cylinder 324 is arranged between the rotor 302 and the stator 312, and the outer cylinder 326 is arranged around the stator 312 and inside the motor casing 322.

The inner cylinder 324 and the outer cylinder 326 extend between the two walls to which they are hermetically attached so that, together with the two walls, they delimit a chamber 328 in which the stator 312 is housed and which can be placed under vacuum.

The coils 320 of a superconducting motor 300 need to be cooled in order to improve their efficiency. To this end, a coolant is injected into each of the apertures 316 in order to cool the coils 320.

FIG. 4 shows an example of a coil 320 from the prior art installed in a pair of apertures 316, which are shown here in phantom lines.

The coil 320 consists of several strips 404, in this case three, which are placed against each other and wound around themselves to form turns. Each strip 404 consists of a superconducting material and two successive strips 404 are electrically insulated from each other by a layer of electrically insulating material arranged between them.

The coil 320 comprises a first straight section 402a that passes through a first aperture 316 of the pair of apertures 316, and a second straight section 402b that passes through a second aperture 316 of the pair of apertures 316.

The first section 402a and the second section 402b each have a first end 406a-b electrically connected to an electrical power source and a second end 408a-b.

The coil 320 also comprises at least one turn 410 that connects the second ends 408a-b to each other. Each turn 410 comprises straight sections that pass through one of the two apertures 316 and curved sections that are outside the apertures 316 and link the straight sections to each other.

Although such an arrangement produces good results, the passage of current through the coil 320 and the change in polarity of the magnetic field to which the coil 320 is subjected generate losses, and it is therefore desirable to find an arrangement that limits these losses.

### SUMMARY

One aim of the disclosure herein is to propose a coil system that can be installed in a superconducting motor and that has lower losses than the prior art.

To this end, a coil system for a superconducting motor is proposed that comprises first and second apertures, the coil system comprising:
a coil formed from several strips stacked on each other and wound in such a way as to form a first straight section intended to pass through the first aperture and having a first end and a second end, a second straight section intended to pass through the second aperture and having a first end and a second end, and a winding of at least one turn linking the second ends together and comprising straight sub-sections intended to pass through one of the two apertures and curved sub-sections intended to be outside the apertures and linking the straight sections and sub-sections together, and
for each group comprising a section and each straight sub-section that passes through the same aperture, a shielding system comprising at least one first band and at least one second band made from an electrically superconducting material, in which a first first band is placed against the section or straight sub-section of the coil which is the outermost, in which a first second band is placed against the section or straight sub-section of the coil which is the innermost of the coil,
in which each first end is intended to be electrically connected to an electrical power source,
in which each strip is formed from a superconducting material,
in which two successive strips in the stack are electrically insulated from each other, and
in which each band that is placed next to a strip of the coil is electrically insulated from the strip.

With such an arrangement, the losses are reduced.

Advantageously, there are several first bands and the first bands are placed against each other in such a way as to form a stack that extends towards the outside of the coil.

Advantageously, there are several second bands and the second bands are placed against each other in such a way as to form a stack that extends towards the inside of the coil.

Advantageously, two bands placed next to each other are electrically insulated from each other.

Advantageously, the coil and each shielding system are embedded in a solid resin.

The disclosure herein also proposes a superconducting motor comprising:
a rotor with a rotor core carrying permanent magnets that are able to rotate about a longitudinal axis,
a stator arranged outside the rotor and comprising a stator core traversed by several pairs of first and second apertures distributed at regular angular intervals around the rotor, and
for each pair of apertures, a coil system according to one of the preceding variants.

The disclosure herein also proposes a method for manufacturing a coil system according to the disclosure herein, the manufacturing method comprising:
a first provision step during which an assembly of several strips stacked on each other is provided,
a winding step during which the assembly of strips thus provided is wound onto a mandrel to form the coil,
a removal step during which the coil is removed from the mandrel,
a first reinforcement step during which the coil is impregnated with a resin that solidifies,
a second provision step during which two shielding systems are provided,
a positioning step during which each shielding system is positioned relative to the coil, and
a second reinforcement step during which the coil and the shielding systems thus positioned are impregnated with a resin that solidifies.

### BRIEF DESCRIPTION OF THE DRAWINGS

The abovementioned features of the disclosure herein, and others, will become clearer on reading the description that follows of one embodiment, the description being provided in reference to the appended drawings, in which:

FIG. 1 is a cross-sectional view of a superconducting motor;

FIG. 2 is a perspective view of a coil system according to the disclosure herein;

FIG. 3 is a diagram showing the losses of the prior art compared with the disclosure herein; and

FIG. 4 is a perspective view of a coil of the prior art.

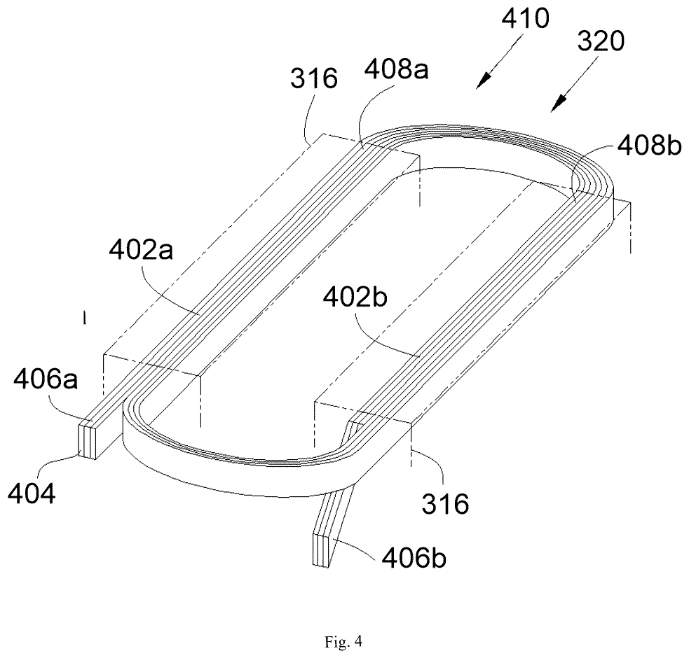

### DETAILED DESCRIPTION

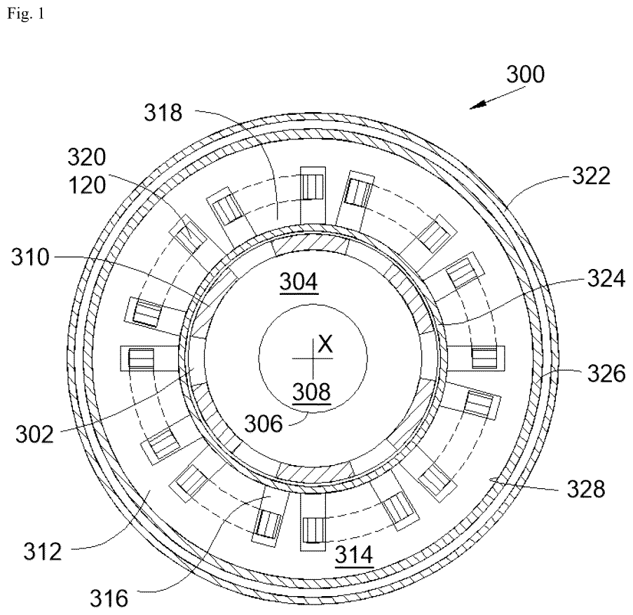

The architecture of a superconducting motor according to the disclosure herein is similar to that of the superconducting motor of FIG. 1 described above, and the difference between the two superconducting motors lies solely in the arrangement of the coils in the apertures. Therefore, the superconducting motor 300 according to the disclosure herein comprises a rotor 302 with a rotor core 304 carrying permanent magnets 310 that are able to rotate about a longitudinal axis X, and a stator 312 arranged outside the rotor 302 and comprising a stator core 314 traversed by several pairs of first and second apertures 316 distributed at regular angular intervals around the rotor 302.

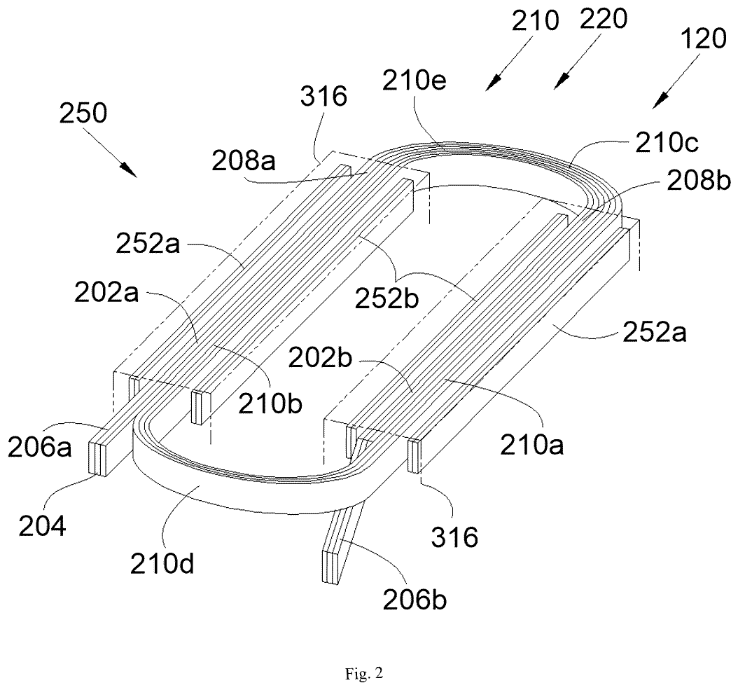

The superconducting motor 300 according to the disclosure herein therefore comprises the same components as those described above except that each coil 320 of the prior art is replaced by a coil system 120 according to the disclosure herein, shown in FIG. 2, and which is installed in a pair of apertures 316 of the stator core 314 of the superconducting motor 300.

The coil system 120 comprises a coil 220 whose construction is identical to that of the prior art. The coil 220 is thus formed from several strips 204 with a rectangular cross section, in this case three, which are placed with their large surfaces against each other in such a way as to form a stack and wound around themselves to form generally planar turns. Each strip 204 is formed from a superconducting material. Two successive strips 204 in the stack are electrically insulated from each other by a layer of an electrically insulating material, such as a layer of polyimide varnish, arranged between them, i.e., an electrically insulating material is arranged between the large contacting surfaces of the two successive strips 204.

The coil 220 comprises a first straight section 202a that passes through a first aperture 316 of the pair of apertures 316, and a second straight section 202b that passes through a second aperture 316 of the pair of apertures 316.

The first section 202a and the second section 202b each have a first end 206a-b electrically connected to an electrical power source and a second end 208a-b. All of the strips 204 are electrically connected to the electrical power source at each first end 206a-b, i.e., the current passes through all of the strips 204 of the coil 220. The strips 204 are thus electrically insulated from each other along the path between the first ends 206a-b but electrically connected at the first ends 206a-b.

The coil 220 also comprises a winding 210 of at least one turn that connects the second ends 208a-b to each other. The winding 210 comprises straight sub-sections that pass through one of the two apertures 316 and curved sub-sections that are outside the apertures 316 and link the straight sections and sub-sections to each other.

In the embodiment of the disclosure herein shown in FIG. 2, the winding 210 has a single turn and comprises a first straight sub-section 210 a that passes through the second aperture 316, a second straight sub-section 210b that passes through the first aperture 316, a third curved sub-section 210c that connects the second end 208a of the first section 202a to the first sub-section 210a, a fourth curved sub-section 210d that connects the first sub-section 210a to the second sub-section 210b and a fifth sub-section 210e that connects the second sub-section 210b to the second end 208b of the second section 202b.

Naturally, the arrangement may be different depending on the number of turns of the winding 210.

The coil system 120 also comprises a shielding system 250 for each aperture 316 through which the coil 220 passes. In other words, for each group comprising a section 202a-b and each straight sub-section 210a-b that passes through the same aperture 316 as the section 202a-b, the coil system 120 comprises a shielding system 250.

The shielding system 250 comprises at least one first band 252a and at least one second band 252b, in which each band 252a-b is made from an electrically superconducting material, such as a metal material, and, more particularly, from the same superconducting material as the strips 204 of the coil 220.

A first first band 252a is placed with its large surface against the large surface of the straight section or of the straight sub-section of the coil 220 which is the outermost of the coil 220. In this case, there is a first first band 252a placed against the first section 202a and a first first band 252a placed against the first sub-section 210a.

When there are several first bands 252a, the other first bands 252a are placed with their large surfaces against the large surface of the first first band 252a placed next to the coil 220 and on the other side of the first first band 252a in relation to the coil 220, in such a way as to form a stack that extends towards the outside of the coil 220.

A first second band 252b is also placed with its large surface against the large surface of the straight section or of the straight sub-section of the coil 220 which is the innermost of the coil 220. In this case, there is a first second band 252b placed against the second section 202b and a first second band 252b placed against the second sub-section 210b.

When there are several second bands 252b, the other second bands 252b are placed with their large surfaces against the large surface of the first second band 252b placed next to the coil 220 and on the other side of the first second band 252b in relation to the coil 220 in such a way as to form a stack that extends towards the inside of the coil 220.

The bands 252a-b are thus to either side of the straight elements forming the coil 220.

In FIG. 2, the bands 252a-b are spaced apart from the coil 220 to facilitate visibility, but they are normally pressed against the coil 220.

Each band 252a-b that is placed next to a strip 204 of the coil 220 is electrically insulated from the strip 204 by installing a layer of an electrically insulating material, such as a layer of polyimide varnish, between them.

None of the bands 252a-b is electrically connected to the electrical power source and they thus form a shield around the elements of the coil 220 that are in the apertures 316.

Installing the shielding systems 250 makes it possible to dissociate the losses caused by the passage of current through the coil 220 and the change in polarity of the magnetic field to which the coil 220 is subjected. The bands 252a-b interact with the magnetic field and absorb hysteresis losses.

According to one particular embodiment, when two bands 252a-b are placed next to each other, they are electrically insulated from each other, for example by installing a layer of an electrically insulating material between them.

According to one particular embodiment, each band 252a-b extends at most over the length of the aperture 316.

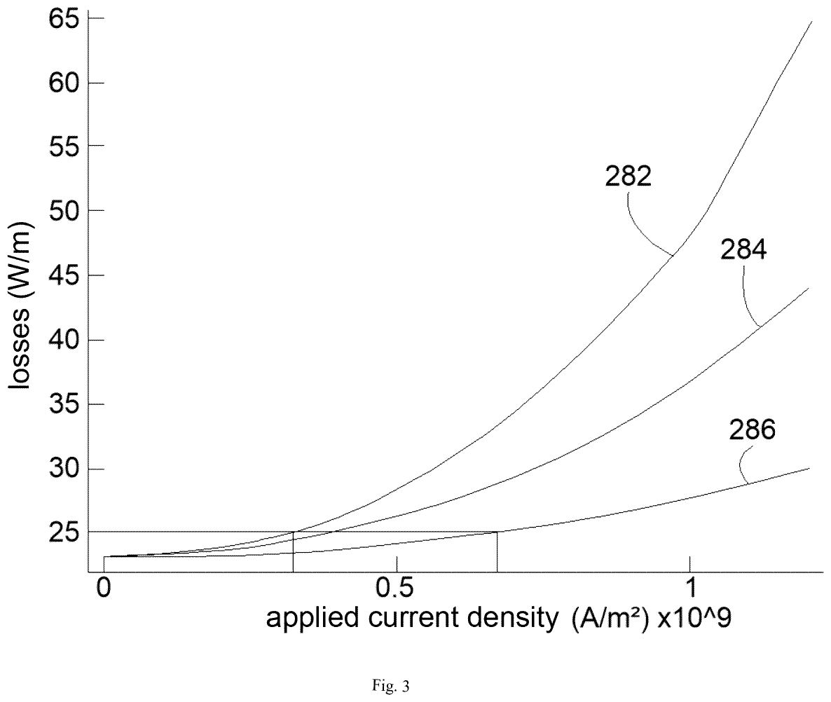

FIG. 3 shows curves representative of losses as a function of the applied current. The curve 282 is representative of a coil of the prior art, i.e., without the shielding systems 250. The curve 284 is representative of a coil according to the disclosure herein, in which each shielding system 250 comprises two first bands 252a and two second bands 252b per aperture 316. The curve 286 is representative of a coil according to the disclosure herein, in which each shielding system 250 comprises three first bands 252a and three second bands 252b per aperture 316.

FIG. 3 therefore shows that the number of bands 252a-b has an influence on the losses. In particular, for the same loss level of 25 W/m, the current is more than doubled between the prior art and the disclosure herein with six bands 252a-b.

With such an arrangement, it is possible to replace some strips 204 with bands 252a-b without increasing the space requirement.

One example of a method for manufacturing a coil system 120 according to the disclosure herein comprises:
a first provision step during which an assembly of several strips 204 stacked on each other is provided,
a winding step during which the assembly of strips 204 thus provided is wound onto a mandrel to form the coil 220,
a removal step during which the coil 220 is removed from the mandrel,
a first reinforcement step during which the coil 220 is impregnated with a resin that solidifies in order to stiffen the coil 220,
a second provision step during which two shielding systems 250 are provided,
a positioning step during which each shielding system 250 is positioned relative to the coil 220, and
a second reinforcement step during which the coil 220 and the shielding systems 250 thus positioned are impregnated with a resin that solidifies in order to stiffen the coil system 120.

The resin is impregnated in liquid form and the solidification takes place after impregnation.

The resin used is, for example, an epoxy resin, and the coil 220 and each shielding system 250 are thus embedded in a solid resin.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A coil system for a superconducting motor comprising first and second apertures, the coil system comprising:
a coil formed from several strips stacked on each other and wound to form a first straight section for passing through the first aperture and having a first end and a second end, a second straight section for passing through the second aperture and having a first end and a second end, and a winding of at least one turn linking the second ends together and comprising straight sub-sections for passing through one of the first and second apertures and curved sub-sections to be outside the first and second apertures and linking the straight sections and sub-sections together; and
for each group comprising a section and each straight sub-section that passes through the same aperture, a shielding system comprising at least one first band and at least one second band made from an electrically superconducting material, in which a first first band is placed against the section or the straight sub-section of the coil which is an outermost, in which a first second band is placed against the section or straight sub-section of the coil which is an innermost of the coil;
wherein each first end is configured to be electrically connected to an electrical power source;
wherein each strip is formed from a superconducting material;
wherein two successive strips in the stack are electrically insulated from each other; and
wherein each band that is placed next to a strip of the coil is electrically insulated from the strip.

2. The coil system of claim 1, comprising several first bands and wherein the first bands are placed against each other to form a stack that extends towards an outside of the coil.

3. The coil system of claim 1, comprising several second bands, and wherein the second bands are placed against each other to form a stack that extends towards an inside of the coil.

4. The coil system of claim 2, wherein two bands placed next to each other are electrically insulated from each other.

5. The coil system of claim 1, wherein the coil and each shielding system are embedded in a solid resin.

6. A superconducting motor comprising:
a rotor with a rotor core carrying permanent magnets that are rotatable about a longitudinal axis;
a stator outside the rotor and comprising a stator core traversed by several pairs of first and second apertures distributed at regular angular intervals around the rotor; and
for each pair of apertures, the coil system of claim 1.

7. A method for manufacturing the coil system of claim 1, the manufacturing method comprising:
a first provision step during which an assembly of several strips stacked on each other is provided;
a winding step during which the assembly of strips provided is wound onto a mandrel to form the coil;
a removal step during which the coil is removed from the mandrel;
a first reinforcement step during which the coil is impregnated with a resin that solidifies;
a second provision step during which two shielding systems are provided;
a positioning step during which each shielding system is positioned relative to the coil; and
a second reinforcement step during which the coil and the shielding systems thus positioned are impregnated with a resin.
